(19) United States
(12) Patent Application Publication
(10) Pub. No.: US 2023/0203746 A1
(43) Pub. Date: Jun. 29, 2023

(54) BURNER AND GAS FIRED CLOTHES DRYER

(71) Applicants: CHONGQING HAIER ROLLER WASHING MACHINE CO. , LTD., Chongqing (CN); HAIER SMART HOME CO., LTD., Shandong (CN)

(72) Inventors: Yue FEI, Shandong (CN); Chunfeng ZHANG, Shandong (CN); Xiangzheng SUN, Shandong (CN); Xin GAO, Shandong (CN); Dengfei ZHAO, Shandong (CN)

(73) Assignees: CHONGQING HAIER ROLLER WASHING MACHINE CO. , LTD., Chongqing (CN); HAIER SMART HOME CO., LTD., Shandong (CN)

(21) Appl. No.: 18/171,518

(22) Filed: Feb. 20, 2023

Related U.S. Application Data
(63) Continuation of application No. PCT/CN2021/106818, filed on Jul. 16, 2021.

(30) Foreign Application Priority Data
Aug. 21, 2020 (CN) 202010848705.4

(51) Int. Cl. D06F 58/26; F23D 14/10

(52) U.S. Cl. CPC D06F 58/263; F23D 14/105

(57) ABSTRACT

The disclosure provides a burner and a gas-fired clothes dryer, where the burner includes a combustion barrel, a barrel-shaped gas mixing part and a disc-shaped flow guide part, the combustion barrel has a gas inlet, a barrel wall of the combustion barrel is uniformly provided with a plurality of vent holes; the gas mixing part is arranged in the combustion barrel and parallel to an axis of the combustion barrel, a gas inlet end of the gas mixing part is opposite to the gas inlet; the flow guide part is arranged in the combustion barrel and located between a gas outlet end of the gas mixing part and a closed end of the combustion barrel and inclined relative to the axis of the gas mixing part; a diameter of the flow guide part is between a diameter of the combustion

### CROSS-REFERENCE TO RELATED APPLICATIONS

This application is a continuation of International Application No. PCT/CN2021/106818, filed on Jul. 16, 2021, which claims priority to Chinese Patent Application No. 202010848705.4, entitled “BURNER AND GAS-FIRED CLOTHES DRYER”, and filed with the China National Intellectual Property Administration on Aug. 21, 2020. The disclosures of the aforementioned applications are hereby incorporated by reference in its entirety.

### TECHNICAL FIELD

The disclosure relates to the technical field of clothes dryers, and in particular, to a burner and a gas-fired clothes dryer.

### BACKGROUND

Gas-fired clothes dryers directly use the heat generated by gas combustion to dry clothes, which has high energy utilization rate and low energy consumption.

Commonly, a gas-fired clothes dryer includes a drum, a hot air duct, a combustion chamber, a burner, an igniter, and a gas pipe. The hot air duct is communicated with the drum and the combustion chamber, respectively. The combustion chamber has an inlet end for gas inflow and an outlet end for gas outflow. The burner includes a conical cylindrical body, a tail end of the conical cylindrical body is communicated with the gas pipe, its head end is connected with a nozzle part, and the nozzle part extends into the combustion chamber and is provided with a plurality of nozzle holes. An ignition end of the igniter protrudes into the combustion chamber and is close to the nozzle holes. When the gas-fired dryer operates and the temperature of the igniter rises to the ignition temperature, the combustible gas enters the inside of the burner through the gas pipe, and then is sprayed into the combustion chamber through the nozzle holes and gets close to the igniter, then the ignition is successful. The combustible gas in the combustion chamber is burned to heat the air, and the heated air enters the drum through the hot air duct to dry the clothes.

However, the combustible gas ejected from the burner is mainly concentrated at an end of the combustion chamber close to the gas pipe, and there is less combustible gas at an end of the combustion chamber away from the gas pipe, resulting in uneven combustion and low heating efficiency.

### SUMMARY

One aspect of the disclosure is to provide a burner, which includes a combustion barrel, a barrel-shaped gas mixing part, and a disc-shaped flow guide part, where one end of the combustion barrel is closed, and the other end of the combustion barrel is provided with a gas inlet, and a barrel wall of the combustion barrel is uniformly distributed with a plurality of vent holes; the gas mixing part is arranged in the combustion barrel in a direction parallel to a central axis of the combustion barrel, and the gas mixing part has a gas inlet end and a gas outlet end, and the inlet end is opposite to a gas inlet; the flow guide part is arranged in the combustion barrel and is located between the gas outlet end of the gas mixing part and the closed end of the combustion barrel, the flow guide part is inclined relative to a longitudinal axis of the gas mixing part; a diameter of the flow guide part is smaller than a diameter of the combustion barrel and larger than an aperture of the gas outlet end of the gas mixing part, and a distance between the flow guide part and the closed end of the combustion barrel is ⅓ to ⅔ of a length of the combustion barrel.

The technical effect of one aspect of the disclosure is that the gas flowing out from the gas outlet end of the gas mixing part is blocked by the flow guide part, and flows into the combustion barrel along the radial direction of the gas mixing part in the middle of the combustion barrel, and diffuses towards two ends of the combustion barrel and then flows into a combustion chamber from the uniformly distributed vent holes, so that the combustion chamber is homogenously filled with the gas, achieving uniform combustion and high heating efficiency.

Another aspect of the disclosure is to provide a gas-fired clothes dryer, which includes the burner provided in one aspect of the disclosure.

Another technical effect of the disclosure is that when the gas-fired dryer is running, the gas flowing out from the gas outlet end of the gas mixing part of the burner is blocked by the flow guide part of the burner, and the gas flows into the combustion barrel along the radial direction of the gas mixing part in the middle of the combustion barrel, and diffuses towards two ends of the combustion barrel and then flows into the combustion chamber from the uniformly distributed vent holes, so that the combustion chamber is homogenously filled with the gas, achieving uniform combustion, which is beneficial to improve the drying efficiency of gas-fired dryers.

### BRIEF DESCRIPTION OF DRAWINGS

FIG. 1 is a schematic structural diagram of a gas-fired clothes dryer according to an embodiment of the disclosure.

FIG. 2 is a schematic structural diagram of a combustion barrel in a burner according to an embodiment of the disclosure.

FIG. 3 is a schematic structural diagram of a gas mixing part in a burner according to an embodiment of the disclosure.

FIG. 4 is a schematic structural diagram of a burner according to an embodiment of the disclosure.

FIG. 5 is a structural section view of a burner according to an embodiment of the disclosure.

FIG. 6 is a front view of a combustion barrel in a burner according to an embodiment of the disclosure.

FIG. 7 is a partial enlarged view of part A in FIG. 6.

FIG. 8 is an exploded schematic diagram of a burner according to an embodiment of the disclosure.

FIG. 9 is a schematic structural diagram of a bracket in a burner according to an embodiment of the disclosure.

FIG. 10 is a schematic diagram of the combination of a burner and a combustion chamber according to an embodiment of the disclosure.

In the attached drawings:

100: gas-fired clothes dryer;

1: box body;

2: combustion chamber;

3: burner;

31: combustion barrel; 311: vent hole; 3111: first vent hole; 3112: second vent hole; 3113: fourth vent hole; 3114: fifth vent hole; 312: guide section;

32: gas mixing part;

33: flow guide part;

34: igniter;

35: bracket; 351: first mounting plate; 352: second mounting plate; 353: connecting plate; 354: connecting arm;

36: flame detector;

37: nozzle;

38: flow-stabilizing net;

39: guide groove.

### DESCRIPTION OF EMBODIMENTS

First of all, persons of ordinary skill in the art should understand that these embodiments are only used for explanation of the technical principle of the disclosure, and are not intended to limit the protection scope of the disclosure. Persons of ordinary skill may adjust it as needed so as to adapt to specific applications.

Secondly, it should be noted that in the description of the disclosure, the terms of the direction or positional relationship indicated by the terms “inside” and “outside” and so on are based on the direction or positional relationship shown in the accompanying drawings, which is only for the convenience of description and not intended to indicate or imply that the device or component must have a particular orientation, and be constructed and operate in a particular orientation, and therefore should not be understood as a limitation of the disclosure.

In addition, it should also be noted that, in the description of the disclosure, unless otherwise expressly specified and limited, the terms “connected/connecting” and “connection” should be understood in a broad sense. For example, it may be a fixed connection or a detachable connection, or integrally connected; it may be a mechanical connection or an electrical connection; it may be directly connected or an indirectly connected through an intermediate medium; and it may be the internal communication of the two components. For persons of ordinary skill in the art, the specific meanings of the above terms in the disclosure may be understood according to specific situations.

Gas-fired clothes dryers directly use the heat generated by gas combustion to dry clothes, which has high energy utilization rate and low energy consumption.

Commonly, a gas-fired clothes dryer includes a drum, a hot air duct, a combustion chamber, a burner, an igniter, and a gas pipe. The hot air duct is communicated with the drum and the combustion chamber, respectively. The combustion chamber has an inlet end for gas inflow and an outlet end for gas outflow. The burner includes a conical barrel-shaped body, a tail end of the conical barrel-shaped body is communicated with the gas pipe and the head end of the conical barrel-shaped body is connected with a nozzle part. The nozzle part extends into the combustion chamber and is provided with a plurality of nozzle holes. An ignition end of the igniter protrudes into the combustion chamber and is close to the nozzle holes. When the gas-fired dryer operates and the temperature of the igniter rises to the ignition temperature, the combustible gas enters the inside of the burner through the gas pipe, and then is ejected into the combustion chamber through the nozzle holes and close to the igniter, and then the ignition is successful. The combustible gas in the combustion chamber is burned to heat the air, and the heated air enters the drum through the hot air duct to dry the clothes.

However, the combustible gas ejected from the burner is mainly concentrated at an end of the combustion chamber close to the gas pipe, and there is less combustible gas at an end of the combustion chamber away from the gas pipe, resulting in uneven combustion and low heating efficiency.

The following describes the preferred technical solutions of the gas-fired clothes dryer according to the embodiment of the disclosure.

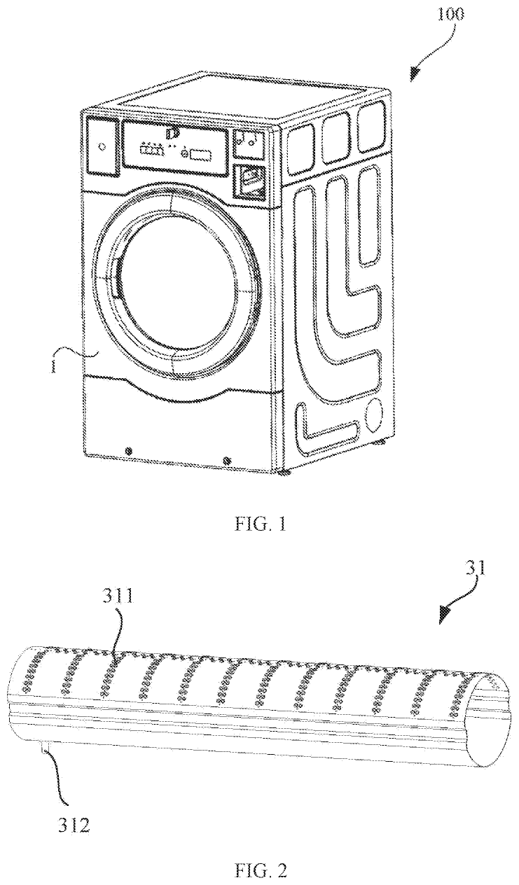

FIG. 1 is a schematic structural diagram of a gas-fired clothes dryer according to an embodiment of the disclosure. Referring to FIG. 1, this embodiment provides a gas-fired clothes dryer 100, which uses the heat generated by combustion of gas to dry clothes. Specifically, the gas-fired clothes dryer 100 includes a box body 1, a drum rotatably disposed in the box body 1, and a fan and a combustion system that are disposed between the box body 1 and the drum and configured for drying clothes in the drum. The box body 1 forms protection for the drum, the fan and the combustion system.

The combustion system includes a gas pipe, a hot air duct and a combustion chamber. The gas pipe is communicated with the combustion chamber. The gas pipe feeds the combustible gas into the combustion chamber, and the combustible gas is burned to heat the air. The hot air duct is communicated with the combustion chamber and the drum respectively. The fan disposed in the hot air duct drives the heated air to enter into the drum to dry clothes. Where the components such as the combustion chamber and the hot air duct in this embodiment are common examples in the related art, and will not be described in detail here.

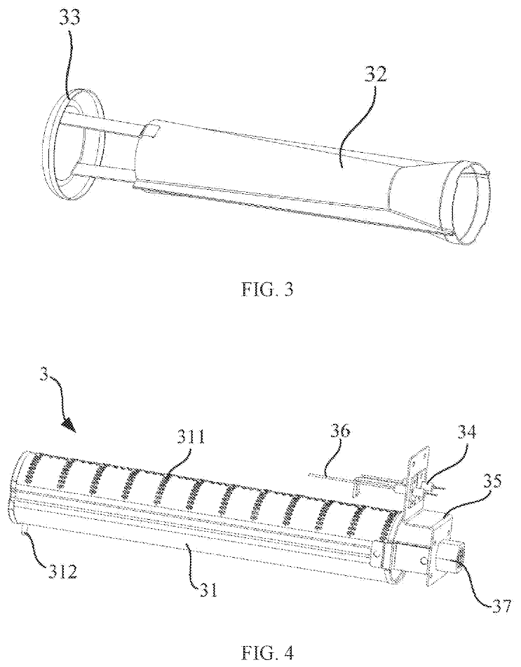

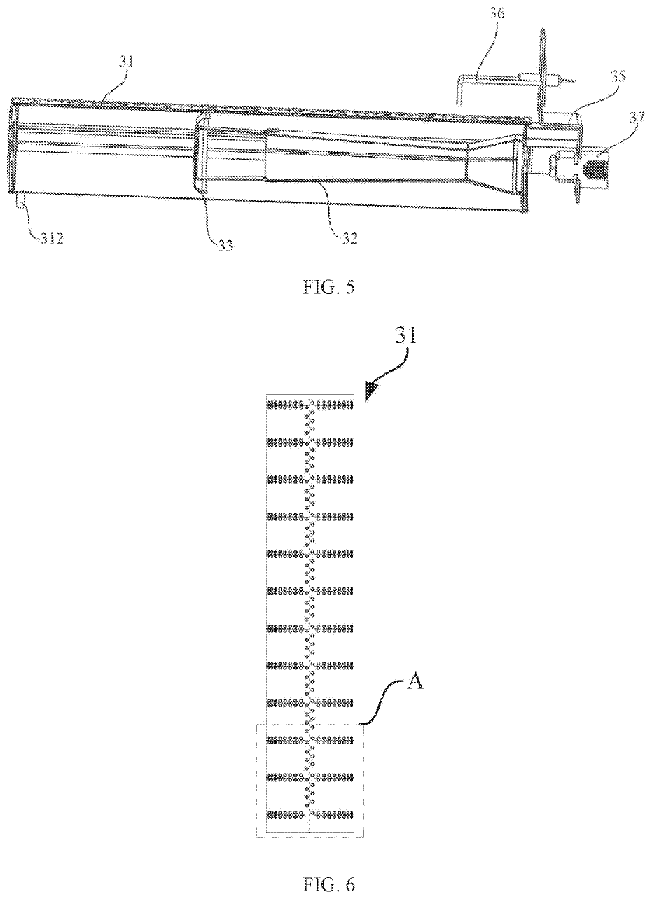

FIG. 2 is a schematic structural diagram of a combustion barrel in a burner according to an embodiment of the disclosure; FIG. 3 is a schematic structural diagram of an gas mixing part in a burner according to an embodiment of the disclosure; FIG. 4 is a schematic structural diagram of a burner according to an embodiment of the disclosure; FIG. 5 is a structural section view of a burner according to an embodiment of the disclosure. As shown in FIG. 2 to FIG. 5, the present embodiment provides a burner 3, which is arranged in the combustion chamber and communicated with the gas pipe for heating the gas introduced into the combustion chamber, so that a flame is formed in the combustion chamber.

Specifically, the burner 3 includes the combustion barrel 31 and the barrel-shaped gas mixing part 32. The gas mixing part 32 is arranged inside the combustion barrel 31 along a direction parallel to the central axis of the combustion barrel 31. In addition, one end of the combustion barrel 31 is closed, and the other end thereof is provided with a gas inlet. The barrel wall of the combustion barrel 31 is evenly distributed with a plurality of vent holes 311. The gas mixing part 32 has a gas inlet end and a gas outlet end. The gas inlet end of the gas mixing part 32 is opposite to the gas inlet of combustion barrel 31. Where, the gas pipe is arranged outside the combustion barrel 31 and is connected to the gas inlet end of the gas mixing part 32.

Based on the above, the gas pipe, the gas inlet of the combustion barrel 31, the gas inlet end of the gas mixing part 32, the gas outlet end of the gas mixing part 32, and the vent holes 311 of the combustion barrel 31 are communicated to each other in sequence to form a flow channel, from which the gas flows into the combustion chamber to be ignited.

The shape of the cross section of the combustion barrel 31 is not limited to a circle, and may be other regular or irregular shapes such as a rectangle, a square, an ellipse, and a rhombus. It should be pointed out that the combustion chamber is arranged horizontally between the drum and the box body 1, and the combustion barrel 31 is also arranged in the combustion chamber in a horizontal direction so as to avoid the combustion system occupying too much installation space in a vertical direction.

The gas mixing part 32 is in a shape of barrel. Similar to the combustion barrel 31, the shape of the cross-section of the gas mixing part 32 is not limited to a circle, but may be other regular or irregular shapes such as a rectangle, a square, an ellipse, and a rhombus. In addition, the dimensions of respective cross sections of the barrel-shaped gas mixing part 32 may be equal or unequal. In the example shown in FIG. 3, the gas mixing part 32 includes a first conical barrel and a second conical barrel, a small-diameter end of the first conical barrel is connected to a small-diameter end of the second conical barrel, a large-diameter end of the first conical barrel is the gas inlet end, and a large-diameter end of the second conical barrel is the gas outlet end. In this way, the gas entering from the gas inlet end flows forward through the small-diameter ends, and the flow speed of the gas is slowed down, thereby facilitating the gas and the air in the gas mixing part 32 to be fully mixed. Where, a length of the first conical barrel is smaller than a length of the second conical barrel.

In addition, a reinforcing rib extending along an axial direction of the gas mixing part 32 is further provided on the outer wall of the gas mixing part 32, and the reinforcing rib extends from the gas inlet end of the gas mixing part 32 to the gas outlet end of the gas mixing part 32. Thereby, the strength of the gas mixing part 32 is improved.

The gas inlet end of the gas mixing part 32 may be directly connected to the inner wall of the combustion barrel 31, or may be connected to the combustion barrel 31 through an intermediate medium, as long as the gas inlet end is communicated with the gas inlet. The connection manner thereof is not limited to welding, and may also be bonding, screwing or snap-fitting.

The burner 3 further includes a disc-shaped flow guide part 33. The flow guide part 33 is arranged in the combustion barrel 31 and is located between the gas outlet end of the gas mixing part 32 and the closed end of the combustion barrel 31. The flow guide part 33 is inclined relative to the longitudinal axis of the gas mixing part 32, the diameter of the flow guide part 33 is smaller than that of the combustion barrel 31 and is larger than the aperture of the gas outlet end of the gas mixing part 32. In this way, most of the gas flowing out from the gas outlet is blocked by the flow guide part 33, and the flow direction of gas changes from a flow along the axial direction of the gas mixing part 32 to a flow from a gap between the gas mixing part 32 and the flow guide part 33, so that the gas can diffuse and flow to the vent holes 311 successfully.

There is a preset angle between the flow guide part 33 and the longitudinal axis of the gas mixing part 32, and the preset angle is between 30 degrees and 150 degrees. For example, as shown in FIG. 3, the preset angle may be 90 degrees, that is, the guide part 33 is arranged perpendicular to the longitudinal axis of the gas mixing part 32, at this point, the flow guide part 33 has a good blocking effect on the gas, so that most of the gas flowing out of the gas outlet end flows in a direction perpendicular to the longitudinal axis of the gas mixing part 32 so as to reach the vent holes 311. Alternatively, the preset included angle may be 150 degrees, at this point, the flow guide part 33 plays a certain role in guiding the gas to the vent holes 311 at the closed end of the combustion barrel 31.

The flow guide part 33 may be connected to the inner wall of the combustion barrel 31. For example, the inner wall of the combustion barrel 31 is provided with a plurality of support parts at intervals along its radial direction, and the flow guide part 33 is connected to the support parts. Where, the support part may be a block-like structure, and may also be a rod-like structure or a plate-like structure, as long as there is a gap between the flow guide part 33 and the combustion barrel 31 which allows gas to circulate. Of course, in an alternative embodiment, the flow guide part 33 may also be connected to the gas mixing part 32, for example, in the example shown in FIG. 3, the flow guide part 33 is connected with the outer wall of the gas mixing part 32 at the gas outlet end through connecting rods.

It should be noted that a distance between the flow guide part 33 and the closed end of the combustion barrel 31 is ⅓ to ⅔ of a length of the combustion barrel 31. That is, the gap between the flow guide part 33 and the gas mixing part 32 is generally located in the middle of the combustion barrel 31. In this way, the gas blocked by the flow guide part 33 can diffuse in the middle of the combustion barrel 31 towards the vent holes 311 that are located at both ends, so that both ends of the combustion chamber can be filled with gas, which is conducive to avoiding the concentration of gas entering the combustion chamber at an end close to the gas pipe and facilitates uniform combustion.

To sum up, for the burner 3 provided in this embodiment, the gas from the gas outlet end of the gas mixing part 32 is blocked by the flow guide part 33 and flows to the combustion barrel 31 along the radial direction of the gas mixing part 32 in the middle of the combustion barrel 31. Then, it diffuses to both ends of the combustion barrel 31, and flows into the combustion chamber from the uniformly distributed vent holes 311, so that the combustion chamber is homogeneously filled with gas, thereby achieving uniform combustion and high heating efficiency.

It should be understood that the vent holes 311 may be uniformly distributed in the entire barrel wall of the combustion barrel 31, or may be only distributed on part of the barrel wall of the combustion barrel 31. For example, as shown in FIG. 2 and FIG. 4, the vent holes 311 are distributed on half of the barrel wall of the combustion barrel 31.

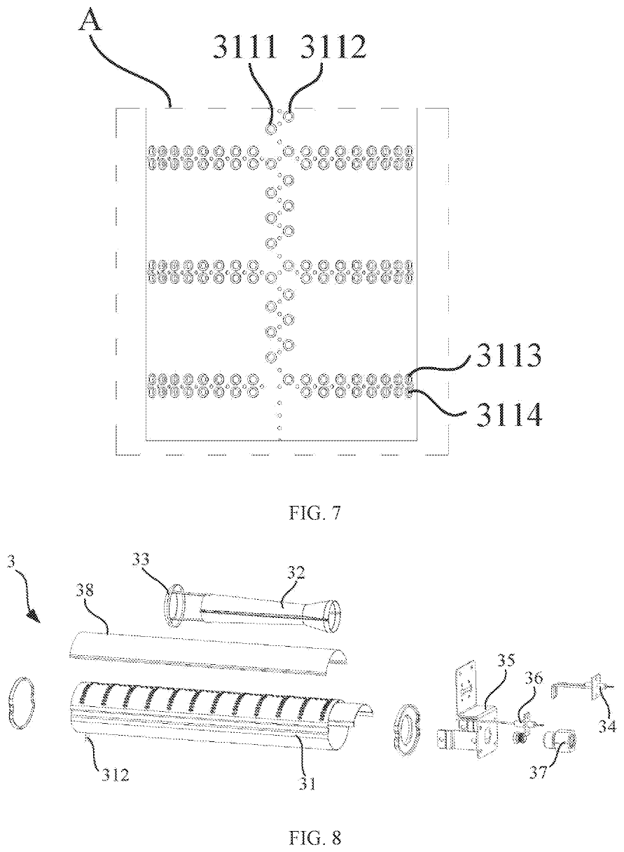

FIG. 6 is a front view of a combustion barrel in a burner according to an embodiment of the disclosure, and FIG. 7 is a partial enlarged view of part A in FIG. 6. The shape, size and arrangement of the vent holes 311 may be various, which are not limited in this embodiment. In a realizable example of the vent holes 311, referring to FIG. 6 and FIG. 7, the vent holes 311 includes a plurality of first vent holes 3111 and a plurality of second vent holes 3112 that are uniformly arranged along the axial direction of the combustion barrel 31. A plurality of first vent holes 3111 and a plurality of second vent holes 3112 are respectively arranged on both sides of a straight line; and an outer edges of each first vent holes 3111 and each second vent holes 3112 protrude outwards to form flanges, in other words, the first vent holes 3111 and the second vent holes 3112 are flanged holes. By arranging the flanges, there is a certain distance between the gas overflowing from the first vent holes 3111 and from the second vent holes 3112 and the barrel wall of the combustion barrel 31. When the gas is ignited, there may also a certain distance between the bottom of the formed flame and the barrel wall of the combustion barrel 31, which increases the height of the flame.

Where, the first vent holes 3111 and the second vent holes 3112 may be symmetrically arranged on both sides of the straight line, or may be staggered on both sides of the straight line. A preferred example of this embodiment is that the first vent holes 3111 and the second vent holes 3112 are staggered on both sides of the straight line. Therefore, the gas overflowing from the first vent holes 3111 and the second vent holes 3112 will not be mixed together, so as to ensure the formation of multiple clusters of flames. Exemplarily, the diameter of the first vent holes 3111 may be 2 mm, and the height of the flange may be 1.5 mm. The second vent hole 3112 is similar to the first vent hole 3111, and the details will not be described here.

Further, the vent holes 311 further include a plurality of third vent holes arranged at intervals on the straight line, and the third vent holes are staggered with the first vent holes 3111 and the second vent holes 3112. Since there is no protrusion formed on the outer edge of the third vent hole, the gas flowing out of the third vent holes is able to continuously provide gas to the bottom of the flame formed at the first vent holes 3111 and the second vent holes 3112, so that the flame burns more stably, thereby preventing the flame from being extinguished. Preferably, the diameter of the third vent hole is smaller than those of the first vent hole 3111 and the second vent hole 3112, for example, the diameter of the third vent hole is 1 mm. In this way, the gas flowing out from the third vent hole can form an elongated airflow, so as to stably supply the gas to the flame.

In addition, the vent holes 311 further includes a plurality of fourth vent holes 3113 and a plurality of fifth vent holes 3114 arranged along the radial direction of the combustion barrel 31, and the plurality of fourth vent holes 3113 and the plurality of fifth vent holes 3114 are respectively arranged on both sides of an arc line. In addition, the outer edges of each fourth vent hole 3113 and each fifth vent hole 3114 have flanges protruding outward, in other words, the fourth vent hole 3113 and the fifth vent hole 3114 are flanged holes. By arranging the flanges, there is a certain distance between the gas overflowing from the fourth vent holes 3113 and from the fifth vent holes 3114 and the barrel wall of the combustion barrel 31. When the gas is ignited, there may also a certain distance between the bottom of the formed flame and the barrel wall of the combustion barrel 31, which increases the height of the flame.

Where, the fourth vent holes 3113 and the fifth vent holes 3114 may be symmetrically arranged on both sides of the arc line, or may be arranged in a staggered manner on both sides of the arc line. A preferred example of this embodiment is that the fourth vent holes 3113 and the fifth vent holes 3114 are symmetrically arranged on both sides of the arc line. Thereby, the gas flowing out from the fourth vent holes 3113 and the fifth vent holes 3114 may be mixed together, making the fire of the formed flame larger. Similar to the first vent holes 3111 and the second vent holes 3112, the diameter of the fourth vent hole 3113 and the fifth vent hole 3114 may be 2 mm. Preferably, a distance between a center of the fourth vent hole 3113 and the arc line and a distance between a center of the fifth vent hole 3114 and the arc line are each 0.5 mm-1.5 mm. Therefore, the fourth vent holes 3113 and the fifth vent holes 3114 are arranged adjacent to each other to ensure that the gas from the fourth vent holes 3113 and the fifth vent holes 3114 can be combined into one.

Further, the vent holes 311 further include a plurality of sixth vent holes arranged at intervals on the arc line, and the sixth vent holes and the fourth vent holes 3113 are arranged in staggered manner. Since there is no protrusion formed on the outer edge of the sixth vent hole, the gas flowing out of the sixth vent hole can continuously supply gas to the bottom of the flame formed at the fourth vent holes 3113 and the fifth vent holes 3114, making the flame combustion more stable and preventing the flame from being extinguished. Preferably, a diameter of the sixth vent hole is smaller than that of each of the fourth vent hole 3113 and the fifth vent hole 3114, for example, the diameter of the sixth vent hole is 1 mm. In this way, the gas flowing out from the sixth vent holes can form an elongated airflow, so as to stably supply the gas to the flame.

In another realizable example of the vent holes 311, the vent holes 311 include a plurality of seventh vent holes uniformly distributed on another arc line, and there is an included angle between the another arc line and the radial direction of the combustion barrel 31, that is, the arc line is obliquely arranged on the combustion barrel 31.

FIG. 8 is an exploded schematic view of a burner according to an embodiment of the disclosure. In some examples of this embodiment, as shown in FIG. 8, the burner 3 further includes a flow-stabilizing net 38 located in the combustion barrel 31. The flow-stabilizing net 38 is connected to the inner wall of the combustion barrel 31 and several mesh holes uniformly arranged in the flow-stabilizing net 38 are communicated with the vent holes 311. Thus, the flow-stabilizing net 38 intervenes in the gas in advance, so that the gas passing through the flow-stabilizing net 38 forms a well-organized gas flow that passes through the vent holes 311 for combustion, which is conducive to improving the stability of flame combustion. For example, the flow-stabilizing net 38 may be a 100-mesh fine net.

It should be noted that when the vent holes 311 are uniformly distributed on the entire barrel wall of the combustion barrel 31, the flow-stabilizing net 38 is also barrel-shaped; when the vent holes 311 are only distributed on part of the barrel wall of the combustion barrel 31, the flow-stabilizing net 38 is in a shape of a camber, and the cambered flow-stabilizing net 38 is installed on the inner wall of the combustion barrel 31 at a position opposite to the vent holes 311.

On the basis of the above-mentioned embodiments, the burner 3 further includes an igniter 34 located outside the gas inlet of the combustion barrel 31. The igniter 34 protrudes into the combustion chamber. When the temperature of the igniter 34 rises to an ignition temperature, the igniter 34 sparks to ignite the gas in the combustion chamber, thereby raising the temperature of the air in the combustion chamber to dry the clothes.

The burner 3 further includes a bracket 35 located outside the gas inlet of the combustion barrel 31, the igniter 34 and the nozzle 37 of the gas pipe are simultaneously mounted on the bracket 35, and the nozzle 37 extends into the gas inlet end of the gas mixing part 32 through the gas inlet of the combustion barrel 31 so as to feed the gas into the combustion barrel 31. Compared with the related art in which the igniter 34 and the nozzle 37 are mounted on a bracket 35 respectively, in such arrangement, only one bracket 35 needs to be installed on the combustion barrel 31, and part of the procedure of installing multiple brackets 35 is omitted. At the same time, the integrated installation of the igniter 34 and the nozzle 37 is realized, and the installation is convenient.

FIG. 9 is a schematic structural diagram of a bracket in a burner according to an embodiment of the disclosure. Specifically, as shown in FIG. 4, FIG. 5, FIG. 8 and FIG. 9, the bracket 35 includes a first mounting plate 351 and a second mounting plate 352 which are arranged perpendicular to the axis of the combustion barrel 31 and a connecting plate 353 connecting the first mounting plate 351 and the second mounting plate 352. The first mounting plate 351 is provided with a first mounting port aligned with the gas inlet, and the nozzle 37 is mounted in the first mounting port. The second mounting plate 352 is provided with a second mounting port communicated with the combustion chamber located outside the combustion barrel 31, and the igniter 34 is installed in the second mounting port.

Where, the connecting plate 353 may be vertically connected to the first mounting plate 351 and the second mounting plate 352, or may be connected obliquely to the first mounting plate 351 and the second mounting plate 352. Preferably, the second installation port is configured so that the igniter 34 installed therein is able to be close to the vent holes 311 in the combustion barrel 31 to effectively ignite the gas.

The burner 3 further includes a controller and a flame detector 36 electrically connected to the controller. The flame detector 36 reaches into the combustion chamber and is arranged close to the igniter 34. The flame detector 36 is configured to detect the temperature of the flame in the combustion chamber, so as to send a temperature signal to the controller when the temperature of the flame is relatively low, and the controller controls the gas pipe to increase the amount of gas delivered to the burner 3 based on the received temperature signal, so as to ensure a higher temperature in the combustion chamber.

Preferably, the flame detector 36 is also arranged on the bracket 35. Therefore, the flame detector 36, the igniter 34 and the nozzle 37 are integrally mounted on the bracket 35, which saves part of the procedure of installing a plurality of brackets 35 and improves the installation efficiency. Specifically, the second mounting plate 352 of the bracket 35 is provided with a third mounting port, which is connected to the combustion chamber located outside the combustion barrel 31; and the flame detector 36 is mounted in the third mounting port. In the example shown in FIG. 9, the third installation port and the second installation port are arranged side by side. When the second installation port is configured so that the igniter 34 installed therein can be close to the vent holes 311 in the combustion barrel 31, correspondingly, the flame detector 36 installed in the third installation port can also be close to the vent holes 311, thereby ensuring that the flame detector 36 can get close to the flame to effectively detect the temperature of the flame.

The bracket 35 may be welded to the combustion barrel 31, or may be bonded or clamped to the barrel, which is not limited in this embodiment. In the example of FIG. 9, both sides of the first installation plate 351 are connected with connecting arms 354 respectively, and the connecting arms 354 extend in a direction parallel to the central axis of the first installation port to be screwed with both sides of the barrel wall of the combustion barrel 31. Further, the connecting arm 354 is provided with a stop surface abutting against one end of the gas inlet of the combustion barrel 31. Therefore, during its installation, the bracket 35 is easily installed in place, which is convenient for installation.

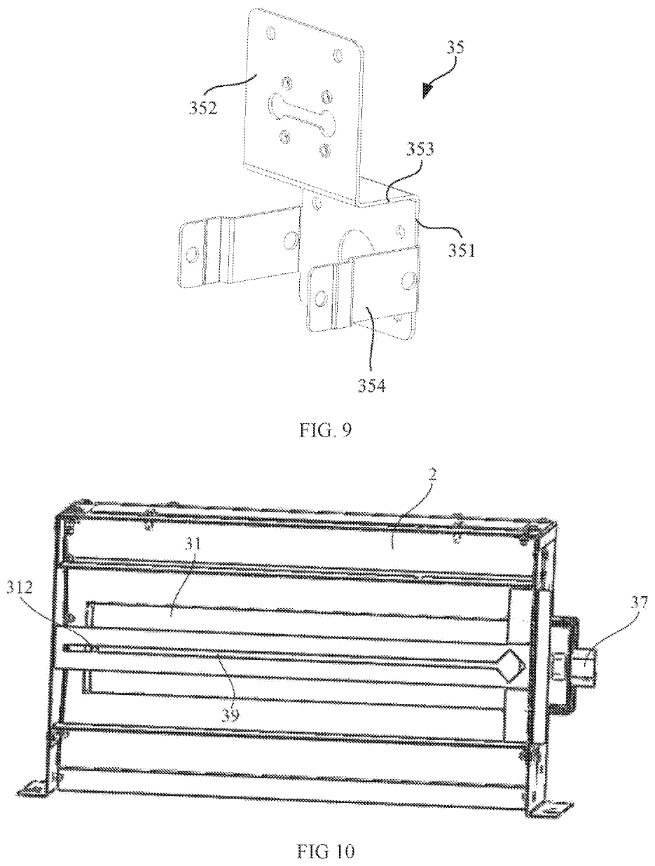

FIG. 10 is a schematic diagram of the combination of the burner and the combustion chamber according to the embodiment of the disclosure. In other examples of this embodiment, as shown in FIG. 10, a guide section 312 is further provided on the barrel wall of the combustion barrel 31. The guide section 312 is configured to be slidably arranged in a guide groove 39, which is arranged on the inner wall of the combustion chamber 2 and extends in the horizontal direction. During installation of burner 3, a part of the burner 3 extends into the combustion chamber 2 in the horizontal direction and the guide section 312 reaches into the guide groove 39, and then the burner 3 is pushed in the horizontal direction, and the guide section 312 slides along the guide groove 39, until the burner 3 is accommodated in the combustion chamber 2, so that it is installed in place.

Such arrangement makes it easier to install the burner 3 at an accurate position; compared with the related art where the combustion chamber 2 needs to be dismantled in order to install the burner 3, in other words, it is accurate and convenient for installation.

Preferably, the guide section 312 is disposed close to the closed end of the combustion barrel 31. Therefore, during installation of burner 3, only a small part of the burner 3 needs to be extended into the combustion chamber 2, that is, the guide section 312 can be matched with the guide groove 39.

Where, the guide groove 39 may be formed by a depression of the inner wall of the combustion chamber 2, and the guide section 312 may be a slider at this time; the guide groove 39 may also be formed by a fixed rail installed on the inner wall of the combustion chamber 2, and the guide section 312 may be a slide rail at this time.

In the example shown in FIG. 10, the guide groove 39 is formed by being jointly surrounded by two guide rods installed on the inner wall of the combustion chamber 2 and the combustion chamber 2, and the guide rods extend in the horizontal direction. At this time, the guide section 312 may be either a guide bolt or a guide stud. When the guide section 312 is the guide bolt, the guide groove 39 includes a mounting groove that is disposed near the gas inlet of the combustion barrel 31 and a sliding groove communicating with the mounting groove. The sliding groove extends in the horizontal direction, and the mounting groove is configured to allow a bolt head of the guide bolt to pass through, and the slide groove is configured to allow the stud of the guide bolt to be accommodated therein, while the bolt head cannot be accommodated therein. During installation of burner 3, part of the burner 3 extends into the combustion chamber 2, and the guide bolt is accommodated in the installation groove, and then the burner 3 is pushed in the horizontal direction until the burner 3 is accommodated in the combustion chamber 2.

To sum up, the gas-fired clothes dryer 100 according to the embodiment of the disclosure includes the combustion barrel 31, the barrel-shaped gas mixing part 32 and the disc-shaped flow guide part 33. One end of the above combustion barrel 31 is closed, and the other end thereof is provided with the gas inlet. The barrel wall of the combustion barrel 31 is uniformly distributed with a plurality of vent holes 311. The above gas mixing part 32 is arranged in the combustion barrel 31 along the direction parallel to the central axis of the combustion barrel 31. The gas mixing part 32 has the gas inlet end and the gas outlet end, and the gas inlet end is opposite to the gas inlet end. The above flow guide part 33 is located in the combustion barrel 31 and between the gas outlet end of the gas mixing part 32 and the closed end of the combustion barrel 31. The flow guide part 33 is inclined relative to the longitudinal axis of the gas mixing part 32. The diameter of the flow guide part 33 is smaller than the diameter of the combustion barrel 31 and larger than the aperture of the gas outlet end of the gas mixing part 32. The distance between the flow guide part 33 and the closed end of the combustion barrel 31 is ⅓ to ⅔ of the length of the combustion barrel 31. By the above arrangement, the gas flowing out from the gas outlet end of the gas mixing part 32 is blocked by the flow guide part 33, flows in the middle of the combustion barrel 31 into the combustion barrel 31 along the radial direction of the gas mixing part 32, diffuses to both ends of the combustion barrel 31, and then flows into the combustion chamber 2 from the uniformly distributed vent holes 311, so that the combustion chamber 2 is homogenously filled with gas, and the combustion is uniform and the heating efficiency is high.

So far, the technical solutions of the disclosure have been described with reference to the preferred embodiments shown in the accompanying drawing; however, persons of ordinary skill in the art may easily understand that the protection scope of the disclosure is obviously not limited to these specific embodiments. Without departing from the principle of the disclosure, persons of ordinary skill in the art may make equivalent modifications or substitutions to the relevant technical features, and the technical solutions after these modifications or substitutions will fall within the protection scope of the disclosure.

What is claimed is:

1. A burner for a combustion chamber of a gas-fired clothes dryer, comprising:
a combustion barrel, wherein one end of the combustion barrel is closed, the other end of the combustion barrel is provided with a gas inlet, and a barrel wall of the combustion barrel is provided with a plurality of uniformly distributed vent holes;
a barrel-shaped gas mixing part arranged in the combustion barrel along a direction parallel to a central axis of the combustion barrel, the gas mixing part having a gas inlet end and a gas outlet end, the gas inlet end being opposite to the gas inlet;
a disc-shaped flow guide part arranged in the combustion barrel and located between the gas outlet end of the gas mixing part and a closed end of the combustion barrel, wherein the flow guide part is inclined relative to a longitudinal axis of the gas mixing part; a diameter of the flow guide part is smaller than a diameter of the combustion barrel and larger than an aperture of the gas outlet end of the gas mixing part; and a distance between the flow guide part and the closed end of the combustion barrel is ⅓ to ⅔ of a length of the combustion barrel.

2. The burner according to claim 1, wherein the vent holes comprise a plurality of first vent holes and a plurality of second vent holes that are arranged along an axial direction of the combustion barrel, the plurality of the first vent holes and the plurality of the second vent holes being respectively arranged on two sides of a straight line, outer edges of each of the first vent holes and the second vent holes being provided with outwardly-protruding flanges.

3. The burner according to claim 2, wherein the plurality of the first vent holes and the plurality of the second vent holes are arranged in a staggered manner on both sides of the straight line.

4. The burner according to claim 2, wherein the vent holes further comprise a plurality of third vent holes arranged at intervals on the straight line, the third vent holes being staggered with the first vent holes and the second vent holes.

5. The burner according to claim 3, wherein the vent holes further comprise a plurality of third vent holes arranged at intervals on the straight line, the third vent holes being staggered with the first vent holes and the second vent holes.

6. The burner according to claim 1, wherein the vent holes further comprise a plurality of fourth vent holes and a plurality of fifth vent holes that are arranged along a radial direction of the combustion barrel, the plurality of the fourth vent holes and the plurality of the fifth vent holes being respectively arranged on both sides of an arc line; outer edges of each of the fourth vent holes and the fifth vent holes being provided with outwardly-protruding flanges.

7. The burner according to claim 6, wherein the plurality of the fourth vent holes and the plurality of the fifth vent holes are symmetrically arranged on both sides of the arc line, respectively.

8. The burner according to claim 6, wherein the vent holes further comprise a plurality of sixth vent holes arranged at intervals on the arc line, the sixth vent holes being staggered with the fourth vent holes.

9. The burner according to claim 7, wherein the vent holes further comprise a plurality of sixth vent holes arranged at intervals on the arc line, the sixth vent holes being staggered with the fourth vent holes.

10. The burner according to claim 1, wherein the flow guide part is arranged perpendicular to the longitudinal axis of the gas mixing part.

11. The burner according to claim 1, wherein the burner further comprises a flow-stabilizing net located in the combustion barrel and connected to an inner wall of the combustion barrel, the flow-stabilizing net being uniformly provided with several mesh holes which are communicated with the vent holes.

12. The burner according to claim 1, wherein the burner further comprises an igniter, a gas pipe and a bracket, that are located outside the gas inlet of the combustion barrel,
the bracket is fixed to the combustion barrel, and the bracket comprises a first mounting plate and a second mounting plate that are arranged perpendicular to the axis of the combustion barrel, and a connecting plate connecting the first mounting plate and the second mounting plate, the first mounting plate is provided with a first mounting port aligned with the gas inlet, the second mounting plate is provided with a second mounting port communicated with the combustion chamber that is located outside the combustion barrel;
a nozzle of the gas pipe is installed in the first installation port, and extends through the gas inlet to the gas inlet end of the gas mixing part;
the igniter is installed in the second installation port and extends into the combustion chamber.

13. The burner according to claim 12, wherein connecting arms are provided on both sides of the first mounting plate, and the connecting arm extends in a direction parallel to a central axis of the first installation port, and the connecting arm is screwed with the barrel wall of the combustion barrel; and
a stop surface is formed on the connecting arm, and the stop surface abuts against the other end of the combustion barrel.

14. The burner according to claim 12, wherein the burner further comprises a flame detector, the second mounting plate is provided with a third installation port, the third installation port is communicated with the combustion chamber that is located outside the combustion barrel, and the flame detector is installed in the third installation port and extends into the combustion chamber.

15. The burner according to claim 1, wherein the barrel wall of the combustion barrel is provided with a guide section, the guide section is configured to be arranged slidably in a guide groove, and the guide groove is arranged on an inner wall of the combustion chamber and extends in a horizontal direction.

16. A gas-fired clothes dryer, comprising: a drum, a hot air duct, a combustion chamber, and the burner according to claim 1, wherein the burner is installed in the combustion chamber.

17. The gas-fired clothes dryer according to claim 16, wherein an inner wall of the combustion chamber is provided with a guide groove, and a guide section that is provided on the combustion barrel in the burner is slidably arranged in the guide groove.

18. The gas-fired clothes dryer according to claim 17, wherein
the guide section is a guide bolt, the guide bolt comprising a bolt head and a stud;
the guide groove comprises an installation groove and a slide groove communicated with the installation groove, the installation groove is close to the gas inlet of the combustion barrel, the installation groove is configured to allow the bolt head to pass through, the slide groove extends in a horizontal direction, and the slide groove is configured to allow the stud to slide.

19. The gas-fired clothes dryer according to claim 16, wherein the vent holes comprise a plurality of first vent holes and a plurality of second vent holes that are arranged along an axial direction of the combustion barrel, the plurality of the first vent holes and the plurality of the second vent holes being respectively arranged on two sides of a straight line, outer edges of each of the first vent holes and the second vent holes being provided with outwardly-protruding flanges.

20. The gas-fired clothes dryer according to claim 19, wherein the plurality of the first vent holes and the plurality of the second vent holes are arranged in a staggered manner on both sides of the straight line.
